(19) United States
(12) Patent Application Publication
(10) Pub. No.: US 2003/0086412 A1
(43) Pub. Date: May 8, 2003

(54) VoIP gateway system connected through extension subscriber circuit of private branch exchange

(76) Inventors: Jun Hee Jeong, Seoul (KR); Jong Gie Kim, Seoul (KR)

Correspondence Address: Daniel F. Drexler, 55 Griffin South Road, Bloomfield, CT, 06002, US

(21) Appl. No.: 10/155,336

(22) Filed: May 24, 2002

(30) Foreign Application Priority Data
Nov. 2, 2001 (KR) 2001-68242

(51) Int. Cl. H04L 12/66

(52) U.S. Cl. 370/352; 370/401

(57) ABSTRACT

A VoIP gateway system connected through an extension subscriber circuit of a private branch exchange is provided, which includes a switching unit connected to extension terminals of the extension subscriber circuit of the private branch exchange, the switching unit finding an idle extension line of extension lines of the extension subscriber circuits to perform automatic connection; a voice CODEC connected to the switching unit, to perform modulation and demodulation between a voice signal and a digital signal; a LAN connection part connected to the voice CODEC; and a controller connected with the switching unit, voice CODEC and LAN connection part, for providing control signals for outgoing- and incoming-call operations.

### BACKGROUND OF THE INVENTION

1. Field of the Invention

The present invention relates to a VoIP (Voice over Internet Protocol) gateway connected to a private branch exchange and, more particularly, to a VoIP gateway connected through an extension subscriber circuit of a private branch exchange, which is connected to a small-sized private branch exchange having no regard for the connection of the VoIP gateway, to support a telephone service based on the Internet in the form of phone-to-phone or phone-to-PC.

2. Background of the Related Art

With the propagation of the Internet in recent years, a telephone service based on VoIP and Internet is increasingly used instead of telephone services using a conventional public switched telephone network. Technical development and diffusion of the telephone service using the Internet are being generalized owing to its cheap service rate.

FIG. 1 shows the configuration of a conventional telephone service system based on VoIP and Internet. Referring to FIG. 1, a general public switched telephone network or VoIP gateway can be connected to an office line of a private exchange, for example, private branch exchange or keyphone. In case that a user uses a telephone service based on the public switched telephone network, a common carrier (Korea Telecom, for instance) imposes a service rate on the user. Accordingly, the aforementioned telephone service using the VoIP gateway and Internet is increasingly used because it provides cheap or free service to users. The configuration of a system used for this telephone service based on the VoIP gateway and Internet is illustrated at the upper part of FIG. 1.

However, the conventional system shown in FIG. 1 has a problem in compatibility between the private branch exchange and the VoIP gateway in case that the VoIP gateway is additionally connected to the office line of the private branch exchange previously installed to provide the telephone service through the Internet. Specifically, to connect the VoIP gateway with the private branch exchange that was not made originally for connecting to the VoIP gateway requires development of a hardware interface and correction of drive software stored in the private branch exchange. However, many kinds of private branch exchanges are not suitable for these works and, even if they are, lots of efforts are needed for the works.

The private branch exchange includes a processor board that processes the entire functions required for controlling the exchange. Though a part of the functions is executed using another processor board according to circumstances, all processing program required for processing the exchange is basically installed in the exchange to then be executed. Accordingly, when the program requires correction, a source file is corrected and compiled on a host computer having program source codes. A compiled object file is stored in a ROM or hard disk, which stores program inside the exchange, using a tool specially made. This process is complicated and needs considerable efforts and manpower because it needs a variety of steps.

Meanwhile, the VoIP gateway shown in FIG. 1 is connected through the office line of the private branch exchange so that it is restricted by the number of office lines. In case of the private exchange having four office lines and sixteen extensions, for example, when the VoIP gateway is connected to only the office lines, it restricts the number of available lines.

Furthermore, the telephone service system of FIG. 1 was devised for the Internet phone of extension users. Thus, this system cannot be used when an outside user wants to use the Internet phone service or an extension subscriber is located in a place where he cannot use the extension.

### SUMMARY OF THE INVENTION

Accordingly, the present invention is directed to a VoIP gateway system connected through an extension subscriber circuit of a private branch exchange that substantially obviates one or more problems due to limitations and disadvantages of the related art.

An object of the present invention is to provide a VoIP gateway system capable of supporting a telephone service based on the Internet in the form of phone-to-phone or phone-to-PC merely by connecting with an extension subscriber circuit of a private branch exchange, without correcting the hardware interface with the private exchange and drive software in the private branch exchange, being compatible with any private branch exchange in the market.

Another object of the present invention is to provide a VoIP gateway system that is not restricted by the number of office lines of the private branch exchange.

Still another object of the present invention is to provide a telephone service method that can be easily used by an outside user or an extension subscriber located in a place where he cannot use an extension without being restricted by his location when the outside user or extension subscriber wants to use the telephone service based on the Internet.

To accomplish the objects of the present invention, there is provided a VoIP gateway system connected through an extension subscriber circuit of a private branch exchange, comprising: a switching unit connected to extension terminals of the extension subscriber circuit of the private branch exchange, the switching unit finding an idle extension line of extension lines of the extension subscriber circuits to perform automatic connection; a voice CODEC connected to the switching unit, to perform modulation and demodulation between a voice signal and a digital signal; a LAN connection part connected to the voice CODEC; and a controller connected with the switching unit, voice CODEC and LAN connection part, for outgoing operation, the controller controlling the switching unit to find the idle extension line for making it be in OFF-hook state, the controller originating a VoIP call through the LAN connection part in the event of reception of a called party's telephone number information inputted by an extension subscriber connected through the idle line, the controller controlling the voice CODEC to packetize a voice signal of the extension subscriber for transmitting it to a called party through the LAN connection part and to convert a voice signal of the called party received through the LAN connection part into an analog signal for transmitting it to the extension subscriber when a call message is received from the called party through the LAND connection part, and for incoming operation, the controller controlling the switching unit to find an idle extension line for making it be in OFF-hook state in the even of reception of a VoIP call through the LAN connection part, the controller transmitting a call available message to a calling party through the LAN connection party, controlling the voice CODEC to convert a voice signal of the calling party, received through the LAN connection part, into an analog signal for transmitting it to the extension subscriber connected through the idle extension line, and controlling the voice CODEC to packetize the voice signal of the extension subscriber for transmitting it to the calling party through the LAN connection part when called extension number information inputted by the calling party is received through the LAN connection part.

According to a preferred embodiment of the invention, the switching unit includes: a private branch exchange connection part connected to a plurality of extension terminals of the extension subscriber circuit of the private branch exchange; a ring reception unit for receiving a ring signal from the private branch exchange through the private branch exchange connection part; a DTMF transmission/reception part for transmitting or receiving DTMF to/from the private branch exchange through the private branch exchange connection part; a tone transmission part for transmitting a dial tone to the private branch exchange through the private branch exchange connection part; and an ON/OFF hooking part for ON/OFF hooking an extension line, when a first ring receiver of a first extension line being in the initial connection state detects a ring signal, the controller controls a first ON/OFF hooking part to OFF-hook, ON-hook, and then OFF-book the first extension line, and transmits DTMF tone to an idle nth extension line using a first DTMF transmitter in the final OFF-hook state and, when an nth ring receiver of the nth extension line receives a ring signal, the controller controls an nth ON/OFF hooking part to OFF-hook the nth extension line and ON-hook the first extension line, makes an nth DTMF receiver receivable, and transmits a dial tone to a calling party as a signal for requesting the calling party to input a called party's number using an nth tone transmitter.

To accomplish the objects of the invention, there is also provided a telephone service method using a VoIP gateway connected through an extension subscriber circuit of a private branch exchange, comprising: a step in which a calling party outside attempts to call the private branch exchange using a public switched telephone network; a step in which the calling party inputs an extension number requested by a private branch exchange controller, which detected a ring signal, using a voice ARS; a step in which the calling party hears a dial tone provided by the VoIP gateway system connected through the extension subscriber circuit of the private branch exchange claimed in claim 1 or 2, and inputs a called party's phone number and “#”; and a step in which the calling party speaks with the called party.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 shows the configuration of a conventional telephone service system based on VoIP and Internet;

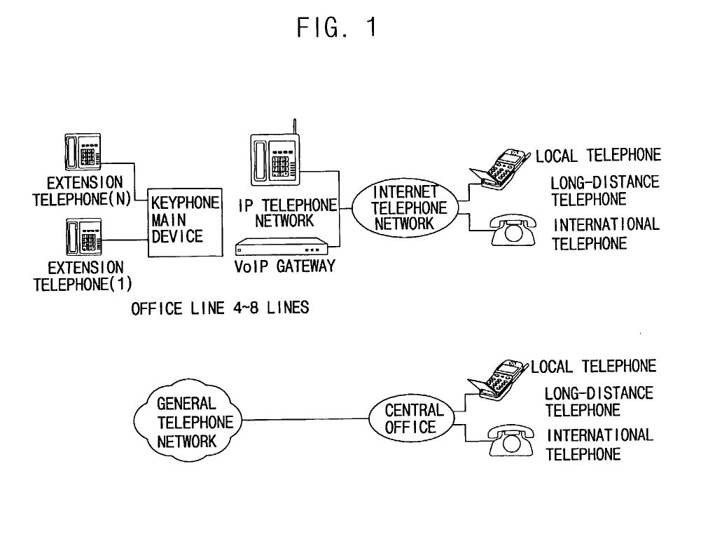

FIG. 2 shows the configuration of a VoIP gateway system according to the present invention; and

FIG. 3 shows a telephone service method using the VoIP gateway system of FIG. 2.

### DETAILED DESCRIPTION OF THE INVENTION

Reference will now be made in detail to the preferred embodiments of the present invention, examples of which are illustrated in the accompanying drawings.

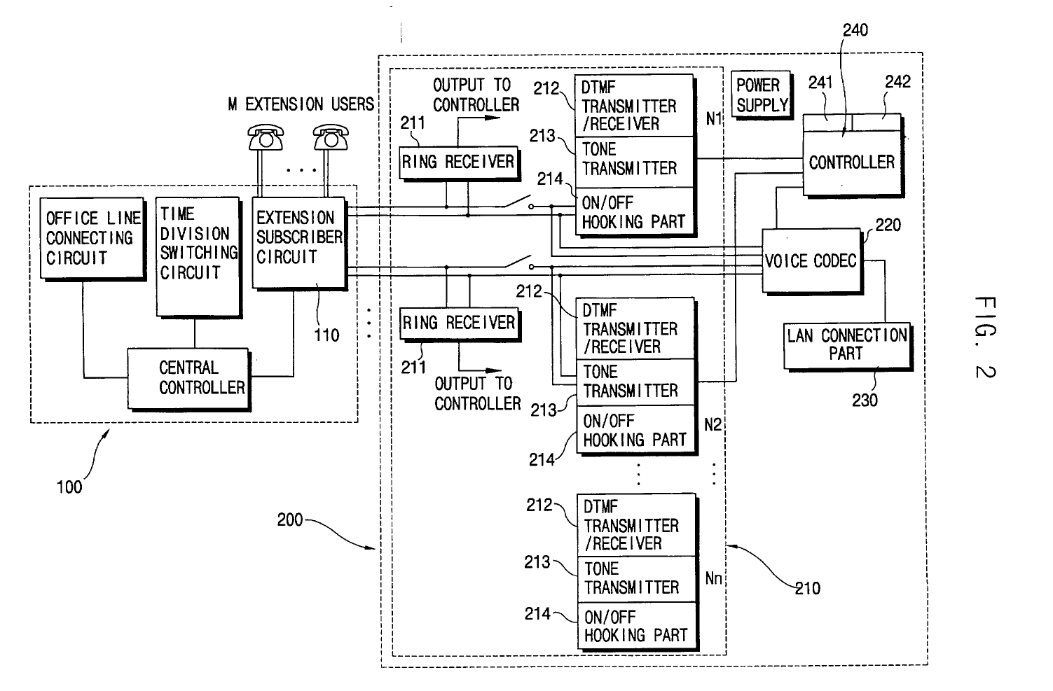

FIG. 2 shows the configuration of a VoIP gateway system 200 according to the present invention. Referring to FIG. 2, the VoIP gateway system 200 includes a switching unit 210 connected to extension terminals of an extension subscriber circuit 110 of a private branch exchange, a voice CODEC 220 connected to the switching unit 210, a LAN connection part 230 connected to the voice CODEC 220, and a controller 240 connected with the switching unit 210, voice CODEC 220 and LAN connection part 230 to control their operations. The VoIP gateway system of the invention is not concerned about the number of ports such as 4, 8, 16 and so on.

Extension subscribers are connected to the extension subscriber circuit 110 through a part of extension lines and the VoIP gateway is connected thereto through the remaining extension lines. Although the extension lines to which the extension subscribers are connected and the extension lines allocated to the VoIP gateway are equivalent lines, the “extension line” means only the extension line allocated to the VoIP gateway hereinafter for convenience of explanation.

The function of each of the components of the VoIP gateway 200 is described. When an extension subscriber attempts to call through a first extension line, the switching unit 210 finds an idle extension line and automatically connects the subscriber to the idle extension line. Accordingly, there is no need for the extension subscriber to personally find the idle extension line to connect. This improves user's convenience. The switching unit 210 includes a ring reception part 211, a DTMF transmission/reception part 212, a tone transmission part 213 and an ON/OFF hooking part 214. The ring reception part 211 receives a ring signal, that is a calling signal, from the private branch exchange 100. The DTMF transmission part transmits digit information to the private branch exchange 100 and the DMMF reception part receives digit information from the private branch exchange 100. The tone transmission part 213 provides a dial tone to the extension subscribers of the private branch exchange 100. The voice CODEC 220 modulates a voice analog signal into a digital signal or demodulates a digital signal into a voice analog signal. The controller 240 controls each of the components to allow the VoIP gateway 200 to carry out its performance. Specifically, the controller 240 includes a memory 241 and a VoIP protocol unit 242, which are built-in or attached externally. The VoIP protocol unit 242 allows voice and data traffics to be managed by one system and line so that the telephone service can be provided using existing IP networks without any change.

The outgoing and incoming operations of the VoIP gateway system of FIG. 2 and outgoing operation using the VoIP gateway outside the system are explained according to their flow sequences.

1) Outgoing operation

a. An extension subscriber of the private branch exchange 100 calls a first extension line N1 of the gateway, which has already been connected to the private branch exchange 100.

b. The private branch exchange 100 transmits a ring signal to the first extension line.

c. When a first ring receiver 211 of the gateway detects the ring signal sent from the private branch exchange 100, the first ring receiver reports it to the controller 240.

d. The controller 240 controls a first ON/OFF hooking part 214 to OFF-hook, ON-hook, and then OFF-hook the first extension line.

e. The controller 240 allows a first DTMF transmitter to transmit a DTMF tone to an idle nth extension line Nn in the final OFF-hook state.

f. When an nth ring receiver 211 detects the ring signal transmitted from the private branch exchange 100, the nth ring receiver reports it to the controller 240.

g. The controller 240 controls an nth ON/OFF hooking part 214 to OFF-hook the nth extension line and allows the first ON/OFF hooking part 214 to ON-hook the first extension line.

The operations a to g explains the operation that the switching unit 210 finds an idle extension line to automatically connect it with the extension subscriber under the control of the controller 240. Here, the first extension line serves as a kind of representative extension line for connecting the gateway to the private branch exchange. That is, all of extension subscribers can be provided with the telephone service of the present invention by calling the first extension line, and the switching unit 210 finds an idle line and actually allocates an available line to a user under the control of the controller 240. In other words, when the first extension line designated previously is called in the situation that it is unknown if the extension lines allocated to the VoIP gateway are busy or not, the VoIP gateway selects an idle extension line to connect a VoIP call, thereby improving user's convenience.

For this, the controller 240 monitors the allocated extension lines all the time so that it can enable switching to third and fourth extension lines if a second extension line is busy. When all the extension lines other than the first extension line are busy, call connection is accomplished through the first extension line.

h. The controller 240 makes an nth DTMF receiver be in a receivable state and controls an nth tone transmitter to transmit a dial tone to the calling extension subscriber.

i. The calling extension subscriber hears the dial tone, and then dials a called party's phone number and ‘#’.

j. When the nth DTMF receiver receives the first DTMF tone, the controller 240 controls the nth tone transmitter to stop the transmission of the dial tone.

k. The controller 240 controls the DTMF reception part to stop DTMF reception after it accepts ‘#’ DTMF information from the nth DTMF receiver, and allows the VoIP call to originate through the LAN connection part 230.

l. When a call available message is received from the called party through the LAN connection part 230, it is reported to the controller 240.

m. When the called party receives a call message, it is reported to the controller 240.

n. The controller 240 controls the voice CODEC 220 to packetize a voice signal received from the nth extension line and to send the packetized data to the called party through the LAN connection part 230. In addition, the controller allows the voice CODEC 220 to convert packetized data received through the LAN connection part 230 into an analog signal to send it to the calling extension subscriber.

2) Incoming operation

a. When the VoIP call is received though the LAN connection part, it is reported to the controller 240.

b. The controller 240 controls the ON/OFF hooking part 214 to select an idle extension line and OFF-hook it while requesting the extension number the calling party wants to call using a voice ARS. The automatic connection to the idle line can be carried out rapidly because the controller 240 is monitoring the extension lines connected to the private branch exchange 100 all the time, as in the outgoing operation.

c. Simultaneously, the controller allows the call available message to be transmitted to the calling party through the LAN connection part 230.

d. The controller 240 controls the voice CODEC 220 to convert the packetized data received through the LAN connection part into an analog signal and transmit it to the called extension subscriber. Simultaneously, the controller controls the voice CODEC 220 to digitallize the voice signal of the called extension subscriber and convert it into packetized data to send it through the LAND connection part 230.

3) Outgoing operation using the VoIP gateway outside the system

a. An outside user attempts to call the private branch exchange 100 using a public switched telephone network.

b. The private branch exchange that detected a ring signal requests an extension number the user wants to call using the voice ARS.

c. The outside user inputs the extension number allocated to the VoIP gateway system 200 for the request of the voice ARS for the extension number.

d. Subsequent steps are identical to those of the outgoing operation of the VoIP gateway.

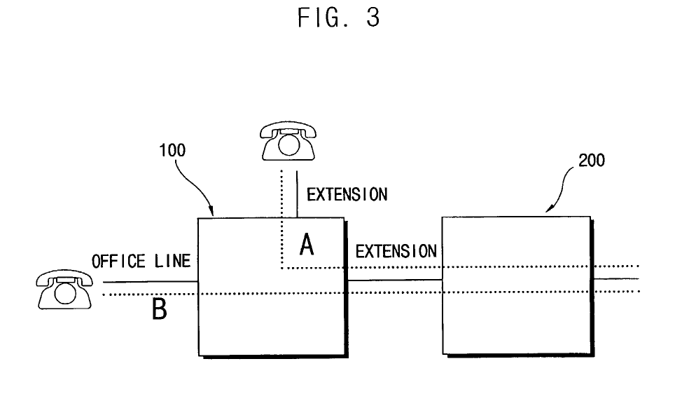

FIG. 3 shows a telephone service method using the VoIP gateway 200 of FIG. 2.

Referring to FIG. 3, the extension subscribers of the private branch exchange 100 can be provided (A) with the Internet phone service through the VoIP gateway 200 of the invention. In addition, even the outside user or extension subscriber located outside can use (B) the Internet telephone service of the invention by connecting with the private branch exchange 100 through the office lines and then connecting with the VoIP gateway 200.

According to the above-described configuration, the present invention can provide the VoIP gateway that can support telephone services based on the Internet in the form of phone-to-phone or phone-to-PC merely by connecting the VoIP gateway to the extension subscriber circuit of the private branch exchange without correcting the hardware interface with the private branch exchange and drive software in the private branch exchange.

Furthermore, the present invention can provide the VoIP gateway system that is not restricted by the number of office line ports of the private branch exchange. Moreover, an outside user or an extension subscriber who is located in a place where he cannot use the extension is able to use the telephone service of the invention without being restricted by his location when he wants to use the Internet-based telephone service.

The forgoing embodiments are merely exemplary and are not to be construed as limiting the present invention. The description of the present invention is intended to be illustrative, and not to limit the scope of the claims. Many alternatives, modifications, and variations will be apparent to those skilled in the art.

According to the present invention, the transmitting part of the microphone system uses the sound modeling procedure and MP3 encoder having no outer loop, and its receiving part employs the optimized MP3 decoder so that the wireless microphone system can provide high sound quality in real time.

What is claimed is:

1. A VoIP gateway system connected through an extension subscriber circuit of a private branch exchange, comprising:
a switching unit connected to extension terminals of the extension subscriber circuit of the private branch exchange, the switching unit finding an idle extension line of extension lines of the extension subscriber circuits to perform automatic connection;
a voice CODEC connected to the switching unit, to perform modulation and demodulation between a voice signal and a digital signal;
a LAN connection part connected to the voice CODEC; and
a controller connected with the switching unit, voice CODEC and LAN connection part, for outgoing operation, the controller controlling the switching unit to find the idle extension line for making it be in OFF-hook state, the controller originating a VoIP call through the LAN connection part in the event of reception of a called party's telephone number information inputted by an extension subscriber connected through the idle line, the controller controlling the voice CODEC to packetize a voice signal of the extension subscriber to transmit it to a called party through the LAN connection part and to convert a voice signal of the called party received through the LAN connection part into an analog signal to send it to the extension subscriber when a call message is received from the called party through the LAND connection part, and for incoming operation, the controller controlling the switching unit to find an idle extension line for making it be in OFF hook state in the even of reception of a VoIP call through the LAN connection part, the controller transmitting a call available message to a calling party through the LAN connection party, controlling the voice CODEC to convert a voice signal of the calling party, received through the LAN connection part, into an analog signal for transmitting it to the extension subscriber connected through the idle extension line, and controlling the voice CODEC to packetize the voice signal of the extension subscriber for transmitting it to the calling party through the LAN connection part when called extension number information inputted by the calling party is received through the LAN connection part.

2. The VoIP gateway system connected through an extension subscriber circuit of a private branch exchange, as claimed in claim 1, wherein the switching unit comprises:
a private branch exchange connection part connected to a plurality of extension terminals of the extension subscriber circuit of the private branch exchange;
a ring reception unit for receiving a ring signal from the private branch exchange through the private branch exchange connection part;
a DTMF transmission/reception part for transmitting or receiving DTMF to/from the private branch exchange through the private branch exchange connection part;
a tone transmission part for transmitting a dial tone to the private branch exchange through the private branch exchange connection part; and
an ON/OFF hooking part for ON/OFF hooking an extension line,
when a first ring receiver of a first extension line being in the initial connection state detects a ring signal, the controller controls a first ON/OFF hooking part to OFF-hook, ON-hook, and then OFF-hook the first extension line, and transmits DTMF tone to an idle nth extension line using a first DTMF transmitter in the final OFF-hook state, and
when an nth ring receiver of the nth extension line receives a ring signal, the controller controls an nth ON/OFF hooking part to OFF-hook the nth extension line and ON-hook the first extension line, makes an nth DTMF receiver receivable, and transmits a dial tone to a calling party as a signal for requesting the calling party to input a called party's number using an nth tone transmitter.

3. A telephone service method using a VoIP gateway system connected through an extension subscriber circuit of a private branch exchange including:
a switching unit connected to extension terminals of the extension subscriber circuit of the private branch exchange, the switching unit finding an idle extension line of extension lines of the extension subscriber circuits to perform automatic connection;
a voice CODEC connected to the switching unit, to perform modulation and demodulation between a voice signal and a digital signal;
a LAN connection part connected to the voice CODEC; and
a controller connected with the switching unit, voice CODEC and LAN connection part, for outgoing operation, the controller controlling the switching unit to find the idle extension line for making it be in OFF-hook state, the controller originating a VoIP call through the LAN connection part in the event of reception of a called party's telephone number information inputted by an extension subscriber connected through the idle line, the controller controlling the voice CODEC to packetize a voice signal of the extension subscriber to transmit it to a called party through the LAN connection part and to convert a voice signal of the called party received through the LAN connection part into an analog signal to send it to the extension subscriber when a call message is received from the called party through the LAND connection part, and for incoming operation, the controller controlling the switching unit to find an idle extension line for making it be in OFF hook state in the even of reception of a VoIP call through the LAN connection part, the controller transmitting a call available message to a calling party through the LAN connection party, controlling the voice CODEC to convert a voice signal of the calling party, received through the LAN connection part, into an analog signal for transmitting it to the extension subscriber connected through the idle extension line, and controlling the voice CODEC to packetize the voice signal of the extension subscriber for transmitting it to the calling party through the LAN connection part when called extension number information inputted by the calling party is received through the LAN connection part,
wherein the telephone service method comprises:
a step in which a calling party outside attempts to call the private branch exchange using a public switched telephone network;
a step in which the calling party inputs an extension number requested by a private branch exchange controller, which detected a ring signal, using a voice ARS;
a step in which the calling party hears a dial tone provided by the VoIP gateway system connected through the extension subscriber circuit of the private branch exchange, and inputs a called party's phone number and “#”; and
a step in which the calling party speaks with the called party.

4. The telephone service method as claimed in claim 3, wherein the VoIP gateway system further includes:
a private branch exchange connection part connected to a plurality of extension terminals of the extension subscriber circuit of the private branch exchange;
a ring reception unit for receiving a ring signal from the private branch exchange through the private branch exchange connection part;
a DTMF transmission/reception part for transmitting or receiving DTMF to/from the private branch exchange through the private branch exchange connection part;
a tone transmission part for transmitting a dial tone to the private branch exchange through the private branch exchange connection part; and
an ON/OFF hooking part for ON/OFF hooking an extension line,
when a first ring receiver of a first extension line being in the initial connection state detects a ring signal, the controller controls a first ON/OFF hooking part to OFF-hook, ON-hook, and then OFF-hook the first extension line, and transmits DTMF tone to an idle nth extension line using a first DTMF transmitter in the final OFF-hook state, and
when an nth ring receiver of the nth extension line receives a ring signal, the controller controls an nth ON/OFF hooking part to OFF-hook the nth extension line and ON-hook the first extension line, makes an nth DTMF receiver receivable, and transmits a dial tone to a calling party as a signal for requesting the calling party to input a called party's number using an nth tone transmitter.
